(19) United States
(12) Patent Application Publication
(10) Pub. No.: US 2024/0211364 A1
(43) Pub. Date: Jun. 27, 2024

(54) METHOD AND SYSTEM FOR DETERMINING A HYBRID TEMPERATURE OF A MEMORY DEVICE

(71) Applicant: SK hynix NAND Product Solutions Corp. (dba Solidigm), San Jose, CA (US)

(72) Inventors: Tim ROTHMAN, San Jose, CA (US); Tai Te LEE, San Jose, CA (US); Tate KOLTON, San Jose, CA (US)

(21) Appl. No.: 18/086,019

(22) Filed: Dec. 21, 2022

(51) Int. Cl. G06F 11/30

(52) U.S. Cl. CPC G06F 11/3058

(57) ABSTRACT

A method, a control system, and computer program product for determining a temperature of a storage device for thermal management of the storage device. This method and controller a) segment calculation of the temperature of the storage device into calculations from a lower temperature region, an upper temperature region, and a scaling region between the lower and upper temperature regions, b) in the lower temperature region, determine a low temperature value from at least one sensor associated with at least one component of the storage device, c) in the upper temperature region, determine a highest temperature value of all sensors in order to protect the storage device from overheating, and d) in the scaling region, determine a scaled intermediate temperature value scaled with respect to a point of entry temperature into the scaling region.

### BACKGROUND

### 1. Field

Embodiments of the present disclosure relate to ascertaining an operating temperature in a storage device such as for example a solid state drive.

### 2. Description of the Related Art

A solid state drive (SSD) is a storage device that stores data in non-volatile memory. Typically, the SSD includes a block-based memory such as NAND Flash and a controller to manage read/write requests received from a host communicatively coupled to the SSD directed to the NAND Flash.

If a working temperature of the SSD is much higher than 70° C., then the temperature of the SSD may exceed the processing upper limit temperature of the SSD main controller or the NAND Flash storage medium, which may cause abnormal operation of the SSD, and perhaps the loss of user data or even physical damage to the SSD. Regarding a working temperature of the SSD, the power consumption of the SSD may have to be adjusted to keep the temperature of the SSD below a predetermined upper limit temperature.

One issue with maintaining a working temperature of SSD devices below a predetermined upper limit is the complexity of their internal design. Specifically, apart from a controller logic die and its associated memory, an SSD may contain hundreds of non-volatile memory chips. Any of these dies may or may not be near a value where the die's correct operation can no longer be guaranteed. For example, an SSD may be “packed together” with other heavily used SSDs in which case both the external and internal ambient temperatures of an SSD in the package may exceed expectations. Similarly, the workload of an SSD can change (e.g., mostly writes to mostly reads, largely targeting one chip than another chip and then mostly targeting the other chip, etc.) which can also change an internal temperature of the SSD.

### SUMMARY

In one embodiment of the invention, there is provided a method for determining a temperature of a storage device for thermal management of the storage device. This method a) segments calculation of the temperature of the storage device into calculations from a lower temperature region, an upper temperature region, and a scaling region between the lower and upper temperature regions, b) in the lower temperature region, determines a low temperature value from at least one sensor associated with at least one component of the storage device, wherein the at least one sensor comprises a most-accurate sensor which is more accurate than other sensors in the low temperature region, c) in the upper temperature region, determines a highest temperature value of all sensors in order to protect the storage device from overheating, and d) in the scaling region, determines a scaled intermediate temperature value scaled with respect to a point of entry temperature into the scaling region.

In another embodiment of the invention, there is provided a control system for thermal management of a storage device, the control system having a controller configured to: a) segment calculation of the temperature of the storage device into calculations from a lower temperature region, an upper temperature region, and a scaling region between the lower temperature region and the upper temperature region, b) in the lower temperature region, determine a low temperature value from at least one sensor associated with at least one component of the storage device, wherein the at least one sensor comprises a most-accurate sensor which is more accurate than other sensors in the low temperature region, c) in the upper temperature region, determine a highest temperature value of all sensors in order to protect the storage device from overheating, and d) in the scaling region, determine a scaled intermediate temperature value scaled with respect to a point of entry temperature into the scaling region.

In another embodiment of the invention, there is provided a controller for determining a temperature of a storage device for thermal management of the storage device. This controller is configured to a) segment calculation of the temperature of the storage device into calculations from a lower temperature region, an upper temperature region, and a scaling region between the lower and upper temperature regions, b) in the lower temperature region, determine a low temperature value from at least one sensor associated with at least one component of the storage device, c) in the upper temperature region, determines a highest temperature value of all sensors in order to protect the storage device from overheating, and d) in the scaling region, determine a scaled intermediate temperature value scaled with respect to a point of entry temperature into the scaling region.

In still another embodiment of the invention, there is provided a computer program product for determining a temperature of a storage device. The computer program product when executed on the controller causes the controller to a) segment calculation of the temperature of the storage device into calculations from a lower temperature region, an upper temperature region, and a scaling region between the lower and upper temperature regions, b) in the lower temperature region, determine a low temperature value from at least one sensor associated with at least one component of the storage device, c) in the upper temperature region, determine a highest temperature value of all sensors in order to protect the storage device from overheating, and d) in the scaling region, determine a scaled intermediate temperature value scaled with respect to a point of entry temperature into the scaling region.

In another embodiment of the invention, there is provided a memory system including a storage device and a controller for determining a temperature of the storage device. The controller is configured to a) segment calculation of the temperature of the storage device into calculations from a lower temperature region, an upper temperature region, and a scaling region between the lower and upper temperature regions, b) in the lower temperature region, determine a low temperature value from at least one sensor associated with at least one component of the storage device, c) in the upper temperature region, determine a highest temperature value of all sensors in order to protect the storage device from overheating, and d) in the scaling region, determine a scaled intermediate temperature value scaled with respect to a point of entry temperature into the scaling region.

Additional embodiments and aspects of the present invention will become apparent from the following description. It is to be understood that both the foregoing general description of the invention and the following detailed description are exemplary, but are not restrictive of the invention.

### BRIEF DESCRIPTION OF THE DRAWINGS

FIG. 1 is a diagram illustrating SSD in accordance with one embodiment of the present invention;

FIG. 2 is a graphical depiction of component temperatures and their respective error bars in accordance with a problem being addressed by at least one embodiment of the invention;

FIG. 3 is a graphical depiction of the component temperatures reported by the inventive hybrid composite temperature determination of the invention in accordance with one embodiment of the invention;

FIG. 4 is a graphical depiction of an operating temperature of an SSD over time as a steady state operation is reached in accordance with one embodiment of the invention;

FIG. 5 is a flowchart depicting the decision tree used in the inventive hybrid composite temperature determination, in accordance with one embodiment of the invention;

FIG. 6 is a flowchart depicting the decision tree used in the inventive hybrid composite temperature determination to derive appropriate scaling factors, in accordance with one embodiment of the invention; and

FIG. 7 is a flowchart illustrating a method for reporting a composite temperature of an SSD, in accordance with one embodiment of the invention.

### DETAILED DESCRIPTION

Various embodiments are described below in more detail with reference to the accompanying drawings. The present invention may, however, be embodied in different forms and thus should not be construed as limited to the embodiments set forth herein. Rather, these embodiments are provided so that this disclosure is thorough and complete and conveys the scope of the present invention to those skilled in the art. Moreover, reference herein to “an embodiment,” “another embodiment,” or the like is not necessarily to only one embodiment, and different references to any such phrase are not necessarily to the same embodiment(s). Throughout the disclosure, like reference numerals refer to like parts in the figures and embodiments of the present invention.

The invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases do not necessarily refer to the same embodiment.

A detailed description of embodiments of the invention is provided below along with accompanying figures that illustrate aspects of the invention. The invention is described in connection with such embodiments, but the invention is not limited to any embodiment. The invention encompasses numerous alternatives, modifications and equivalents within the scope of the disclosure. Numerous specific details are set forth in the following description in order to provide an understanding of the invention. These details are provided for the purpose of example; the invention may be practiced according to the disclosure without some or all of the specific details.

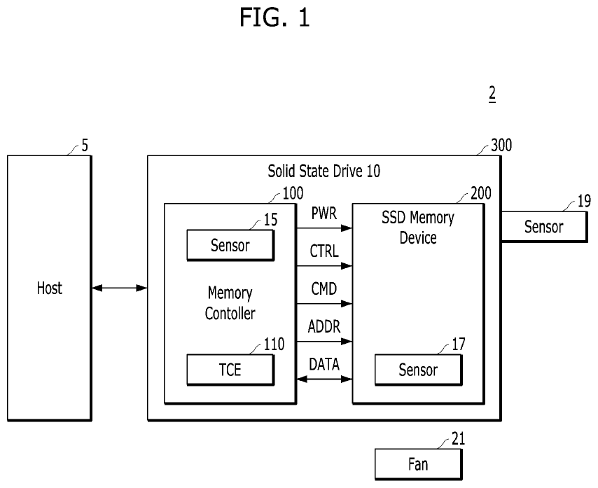

FIG. 1 is a block diagram illustrating an SSD 10 in accordance with one embodiment of the invention. Referring FIG. 1, data processing system 2 includes a host device 5 and the SSD 10 which includes temperature sensors 15, 17, and 19. While shown with three temperature sensors the invention can operate with two or more sensors. The SSD 10 may receive a request from the host device 5 and operate in response to the received request.

The SSD 10 includes a memory controller 100 and an SSD memory device 200 integrated together on board 300. The memory controller 100 may control overall operations of the SSD memory device 200. The memory controller 100 may include application specific integrated circuitry (ASIC) for control of the SSD 10. The SSD memory device 200 may perform one or more erase, program, and read operations under the control of the memory controller 100. The SSD memory device 200 may receive through input/output lines a command CMD, an address ADDR and data DATA. The SSD memory device 200 may receive power PWR through a power line and a control signal CTRL through a control line. The control signal CTRL may include for example a command latch enable signal, an address latch enable signal, a chip enable signal, a write enable signal, a read enable signal, as well as other operational signals depending on design and configuration of the memory system 10.

As shown in FIG. 1, there are temperature sensors 15 and 17 disposed respectively in vicinity of the memory controller 100 and the SSD memory device 200 to sense a temperature representative of those components. As shown in FIG. 1, temperature sensor 19 is disposed in vicinity of board 300. These sensors 15, 17, and 19 may have different accuracies due to factors such as for example 1) the type of sensor (e.g., thermocouple, resistance thermometer, or infrared sensor), 2) the relative placement of the sensors to the sources of heat, or 3) the degree of thermal contact or coupling to the components being sensed. The different accuracies may be manifest for example by different levels of noise observed in the sensed temperature values or by variations in the sensed temperature values upon steady state power and cooling of the SSD 10.

More specifically, while temperature sensor 15 is coupled to (or in thermal communication with) the controller 100, all temperature sensors 15, 17, and 19 may be configured to receive commands from the controller 100, to provide temperature readings to the controller 100, and/or to perform one or more operations such as for example providing instant or averaged temperature readings to controller 100.

In one embodiment of the invention, controller 100 includes temperature calculation engine (TCE) 110 which can calculate temperatures. While shown in FIG. 1 with the TCE 110 existing in memory controller 100, the temperature calculation engine may exist anywhere in communication with memory controller 100. The SSD can feed the calculated temperature to a platform fan 21 which can provide cooling air to the SSD 10 for example as part of the normal operation of SSD10 or may provide additional air flow when the TCE determines that a component of SSD is operating above its expected temperature range. The platform fan 21 may be part of a data center.

The invention in one embodiment provides a hybrid composite temperature determination referred to hereinafter as the “HCT determination.” The inventive HCT determination (which in one embodiment may be implemented by the algorithms shown in the drawings and with the steps described below) provides a more stable and reliable temperature reading while being protective of all components. In data center applications, several drives may be grouped together and thermally controlled using fans by the host. As SSD technology advances, a higher level of accuracy in temperature reporting to optimize thermal control methods is needed. For example, for SSDs of the same type installed in nominally the same environmental conditions, slot location, and workload, the device-to-device composite temperature variation goal between each SSD is expected to be no more than +/−1 degrees ° C. Different devices are expected not to report a composite temperature greater than 2 degrees apart under the same environmental conditions, slot location, and workload. Furthermore, a single device's composite temperature is expected not to vary by more than +/−1 degrees ° C. once a steady state is reached under the same environmental conditions, slot location, and workload.

Prior to the present invention, the accuracy of the reported temperature was limited by the weakest (least accurate) temperature sensor which could be accurate to only +/−4° C. To improve, either the drive hardware would have to be upgraded so that all temperature sensors are accurate to +/−1° C., or a firmware approach such as the inventive HCT determination needs to be taken. Making hardware changes to use more accurate sensors is undesirable because it requires engineering work, product validation, and will likely increase the cost of the drive. As detailed below, the invention's firmware approach addresses this issue by biasing the reported temperature to use the most accurate sensor, while still providing a failsafe in case a lower accuracy sensor component passes its thermal limit.

In one aspect of the invention, SSDs contain multiple internal components with varying thermal limits. Prior to the invention, to report how close a drive was to its temperature limit at any given time, a composite temperature calculation (hereinafter the “CT calculation”) was used in which raw temperature readings from each reporting component (such as from temperature sensors 15, 17, and 19) were “normalized” or “shifted or offset” (or otherwise adjusted) using for example an equation that calculates how close a given component was to its thermal limit, with the highest normalized (or adjusted) temperature of all the sensors reported as the calculated composite temperature.

The conventional CT calculation uses the composite temperature equation below:

$$Tcomposite = max ( T 1 , T 2 , T 3 , … , TN ) \qquad ( eq . 1 )$$

where T1, T2, T3, . . . , TN are the normalized (or adjusted) temperatures from all temperature reporting components. The CT calculation ensures that the component closest to overheating always dominates the reported composite temperature so that proper thermal throttling can occur.

The present invention recognized that eq. 1 for Tcomposite is insufficient for providing +/−1° C. accuracy because it uses input from sensor components, some of which have an accuracy of +/−4° C. For example, board temperature sensor 19 may have +/−1° C. accuracy, while sensors 15, 17 for the ASIC and storage media of memory controller 100 and semiconductor memory device 200, respectively, may have +/−4° C. accuracy. One downside to the CT calculation is that any sensor may dominate the composite temperature, regardless of its temperature accuracy.

One embodiment of the invention provides the HCT determination. In some embodiments, the inventive HCT determination improves accuracy by segmenting calculation of the composite temperature Tcomposite into three regions: a lower region, a scaling region, and an upper region. The HCT determination in one embodiment determines a composite temperature (a low temperature value) in the lower region using only the most accurate sensor. Afterwards, the HCT determination uses (for temperature values outside of a normal operating range of SSD 10) the CT calculation, that is eq. 1, to ensure protective throttling behavior. To transition between the lower region and the upper region, a scaling region is used to provide continuity in the reported composite temperature.

In other words, the inventive HCT determination in one embodiment is a calculation which, in a first calculation mode in a lower temperature region, may utilize only a first mode sensor (the most accurate sensor e.g., the board sensor) to calculate a composite temperature (a low temperature value) of SSD memory 10. When the composite temperature of SSD memory 10 surpasses an operating range temperature threshold and is in the upper temperature region, then the HCT determination transitions to a second calculation mode in which the HCT determination uses eq. 1 to determine the highest temperature (a highest temperature value) of all components (e.g., using all sensors 15, 17, and 19) in order to permit correct thermal throttling behavior. To transition smoothly between these two calculation modes, a scaling period is used in order to have continuity in a calculated temperature reported for example to memory controller 100.

In one aspect of the invention, the quality (reliability) of the calculated temperature data is improved. A reported composite temperature with +/−1° C. accuracy will improve the data being used to control fans and other thermal-management processes. While this value of +/−1° C. accuracy is provided here for illustration purposes, the invention is not limited to this accuracy value.

In one embodiment of the invention, for thermal management, memory controller 100 may power throttle the SSD if an operating temperature becomes too high. Power throttling in the present invention can dynamically alter when each individual command of a plurality of commands is performed so that performance of the commands, in the aggregate, does not exceed a predetermined average power limit or a predefined upper temperature limit.

Indeed, the present invention can utilize a number of techniques to manage power or otherwise control an SSD temperature within required limits. For example, the host 5 or the memory controller 100 of FIG. 1 may employ techniques such as load balancing, “hot spot” prevention, and may regulate the timing of when garbage collection occurs in order to keep the SSD device below the upper temperature limit by not performing garbage collection when the SSD temperature exceeds an upper temperature limit. In one embodiment, host 5 can employ a power management/power-down technique in which the host de-powers a number of target storage devices or directs them to enter a standby/power-down mode when the temperature of the SSD is at or above the upper temperature limit. In one embodiment, host 5 can reduce traffic to a number of devices when the temperature of the SSD is at or above the upper temperature limit. In yet another embodiment, memory controller 100 can employ a device-initiated power management/power-down technique in which memory controller 100 monitors host activity and incoming commands, and can de-power a number of target storage devices or direct them to enter a standby/power-down mode when the temperature of the SSD is at or above the upper temperature limit.

Another approach for power throttling would be to slow the controller's clock and/or run the storage device in a slower bus transfer mode. For example, controller 100 may compare temperature readings from sensors against threshold ranges. If the temperature is in a normal or cold range, the controller 100 can operate at higher clock rates. However, as the temperature increases above the threshold limits, the controller 100 can operate to reduce clock rate(s) and/or bus transfer speeds. The present invention is not limited to any specific power throttling technique. Indeed, the inventive HCT determination discussed above can report an accurate composite temperature for thermal control of the SSD regardless of the power throttling technique applied.

One issue posed by the conventional CT calculation is that it can cause the reported composite temperature of the SSD memory to appear to be lower than any individual component temperature on the solid state drive. For most temperature ranges, this is not an issue as the reported composite temperature is still above ambient temperature. However, for low component temperatures, the composite temperature calculation reported using eq. 1 may be much lower than ambient, or even below 0° C. temperatures. The inventive temperature determination in one embodiment of the invention minimizes this apparent low temperature offset by using only the most accurate sensor (e.g., the board sensor) in the lower region for the low temperature ranges because the warning temperature of the board is the closest to maximum operating temperature of the board compared with other drive components. Although the embodiment of FIG. 1 shows SSD 10 as an example, the present disclosure is not limited thereto. That is, the present disclosure may be applied to other types of storage devices.

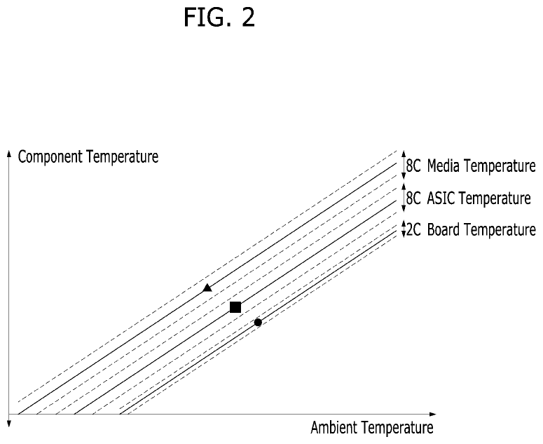

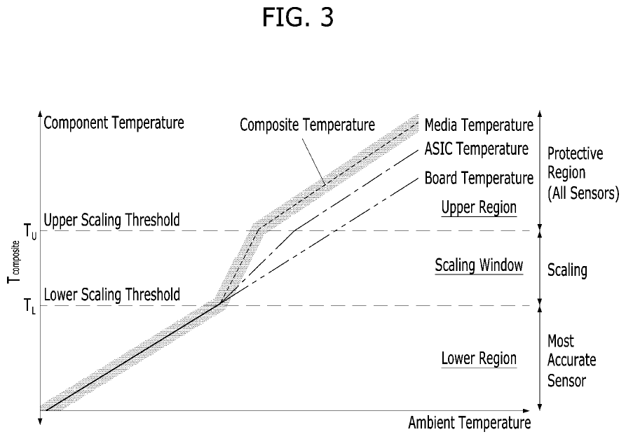

FIGS. 2 and 3 show a comparison between the conventional CT calculation and the inventive HCT determination. More specifically, FIG. 2 is a graphical depiction of component temperatures and their respective error bars, and FIG. 3 is a graphical depiction of the component temperatures reported by the inventive hybrid determination of the invention.

In FIG. 2, conventionally, the reported composite temperature was equal to whatever component had the highest normalized (or adjusted) temperature. If that component was the storage media or ASIC, then the error bars were +/−4° C. (range of 8° C.). If the board temperature was hottest, then the error bars were only +/−1° C. (range of 2° C.).

FIG. 3 shows an example of the inventive HCT determination. The “Composite Temperature” line shows a specific scenario where the storage media temperature (Tmedia) is highest when the scaling window is entered. As such, the composite temperature begins to scale towards Tmedia when Tboard enters the scaling window. The scaling region is exited once Tmedia heats up past the upper scaling temperature. Tcomposite then uses the same equation as the CT calculation (eq. 1) to determine the composite temperature. In the example in FIG. 3, the media temperature in the upper region continues to have the highest composite temperature Tcomposite.

### Lower Region

In the lower region (referred to also as the accurate region), as illustrated in FIG. 3, Tcomposite is equal to the board temperature (Tboard), the Tboard (which in this example is the most accurate sensor) is reported when Tboard is below the lower scaling threshold (TL). In this lower region, Tcomposite has an accuracy equal to the accuracy of the board sensor (currently +/−1° C.) since no other components are contributing to the composite temperature.

### Scaling Region

When Tboard is warmer than TL, the scaling region is entered as illustrated in FIG. 3. The purpose of the scaling region is to provide no jumps in the reported temperature value when the inventive HCT determination switches from considering only the board temperature to considering all the temperature sensor values. To further understand the necessity of a scaling range, consider the following scenario: When Tboard≤TL, it is possible that a component other than the board might have a temperature higher than TL. If there were no scaling region, the reported composite temperature would jump immediately from the board temperature up to the highest temperature (Tmax) (in this case the media temperature) when the board temperature exceeds TL. This discontinuity would complicate host-controlled thermal management and could violate limits for the composite temperature rate of change.

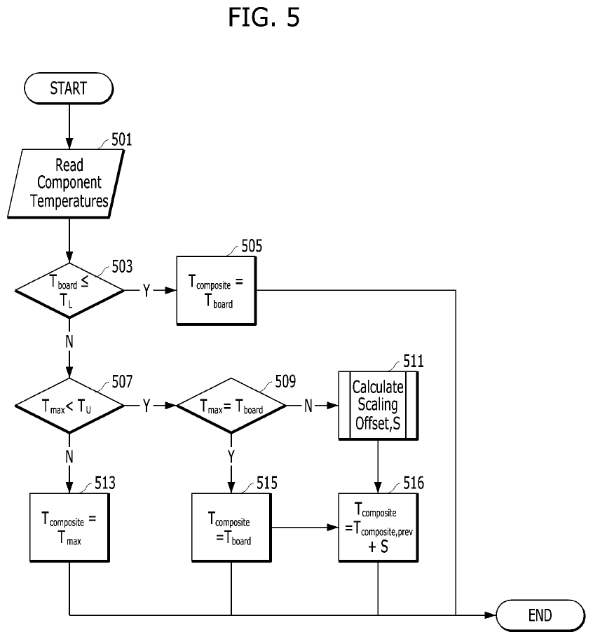

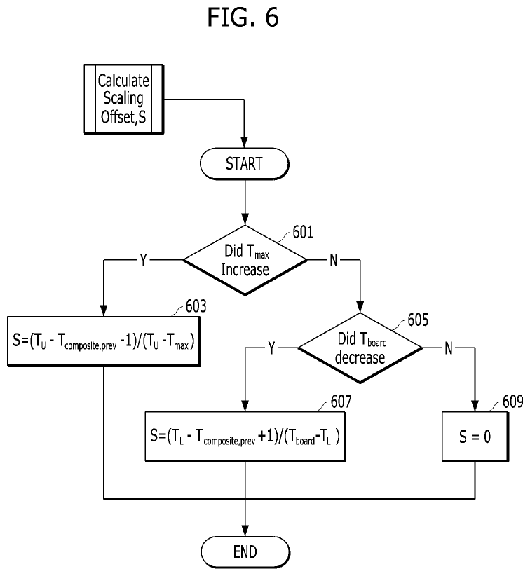

To address this issue, a scaling window is used to transition Tcomposite from Tboard to Tmax over a fixed temperature window from TL to TU. In other words, the point of scaling is to take two separate temperature points at the lower end of the scaling window, (Tmax, Tcomposite) and converge the values at the upper end of the scaling window so that Tcomposite=Tmax=TU. (Determinations of scaling factor offsets are described below in relation to FIGS. 5 and 6.) Similar scaling behavior occurs when the drive is cooling, but the opposite behavior occurs where Tcomposite diverges from Tmax when Tcomposite falls below TU. The exit condition from the scaling region for a cooling drive is: Tcomposite=Tboard when Tboard=TL.

### Upper Region

The reason for converging Tmax and Tcomposite at the upper edge of the scaling region (as illustrated in FIG. 3) is to prepare for the third region of the determination: the upper region. In the upper region (referred to also as a protective region) Tcomposite=Tmax. This is equivalent to the CT calculation (eq. 1) for determining the composite temperature. Using eq. 1 for the upper temperature range protects any component past its thermal limit from overheating and potentially damaging the drive.

### SSD Operation and Normalized Composite Temperature Reporting

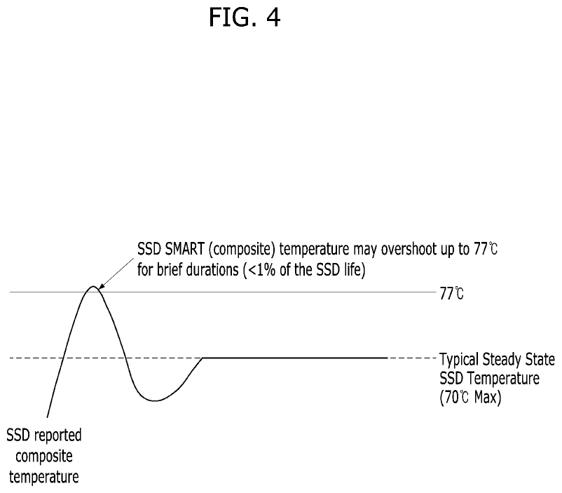

FIG. 4 is a graphical depiction of an operating temperature of an SSD over time as a steady state operation is reached. FIG. 4 shows the need for a throttle requirement (a reduction in power consumption by the SSD) in order for a steady state operating SSD temperature of 70° C. to be reached with platform fans present and operating. With current SSD requirements, 70° C. is considered the maximum steady state temperature at which the platform thermal management (fan control for example) governs to. Above this value, the accuracy of composite temperature no longer needs to be +/−1° C. as the SSD is approaching its thermal limits where the drive needs to be protected. For this reason, in one embodiment of the invention, the scaling region is situated from between 70-77° C. which is the region directly before thermal throttling. This way, when composite temperature is below 70° C. (the lower region), the accuracy of the sensor being used for the composite temperature is +/−1° C. The temperature values and accuracies used here are merely exemplary, and the invention is not limited to these values.

One biproduct of meeting present and future SSD drive requirements is that higher quality (more reliable) temperature data is provided. This can improve the quality and reliability of thermal control systems such as fan control. The quality of a control system depends on the quality of the data being used as feedback, and the inventive HCT determination is a relatively low-cost method for improving the quality of the feedback data.

The inventive HCT determination uses two additional firmware variables compared with the implementation of the calculation (eq. 1). These two variables specify the lower and upper scaling temperatures. The flow charts in FIGS. 5 and 6 illustrate the detailed steps to be implemented in the firmware for the inventive HCT determination. This firmware may implement the operations of FIGS. 5 and 6 when executed for example in TCE 110 of FIG. 1. More specifically, FIG. 5 is a flowchart depicting the decision tree used in the inventive hybrid temperature determination to determine which of the lower temperature region, scaling region, and upper temperature region is being used to determine the composite temperature. FIG. 6 is a flowchart depicting the decision tree used in the inventive hybrid temperature determination to derive appropriate scaling factors when operating in the scaling region.

In FIG. 5, the process starts and at 501 the component temperatures read by the sensors are determined. At 503, the temperature T_{board} of the board sensor (or otherwise of a sensor considered the most accurate) is compared to a preset lower limit temperature T_{L}. If T_{board} is less than or equal to T_{L}, yes, the process proceeds to 505. At 505, a determination is made that the SSD composite T_{composite} is equal to T_{board}, and the process ends. Returning to 503, if T_{board} is not less than or equal to T_{L}, no, the process proceeds to 507. At 507, the maximum temperature for all the sensors Tₘₐₓ is compared to a preset upper limit temperature T_{U}. If Tₘₐₓ is less than T_{U}, yes, the process proceeds to 509. At 509, a comparison is made to determine if Tₘₐₓ is equal to T_{board}. If no (that is Tₘₐₓ is not equal to T_{board}), the process proceeds to 511. At 511, a scaling offset S is calculated. (See FIG. 6). At 516, the scaling offset is added to the previous calculated composite temperature T_{composite, prev}. Returning to 509, if yes (that is that is Tₘₐₓ is equal to T_{board}), the process proceeds to 515. At 515, T_{composite} is set equal to T_{board}. Returning to 507, if no, the process proceeds to 513. At 513, T_{composite} is set equal to Tₘₐₓ. In some embodiments, the steps described in FIG. 5 can be modified by, for example, having steps rearranged, changed, added, and/or removed.

In another embodiment, the inventive HCT determination may be in the low temperature range taking into consideration other sensor values such as the ASIC sensor and the storage media sensor. For example, a weighted average of the board sensor value, the ASIC sensor value, and the storage media sensor value may be used, in which case for the weighted average it would be preferable for more weight to be given to the most accurate sensor (in this example the board sensor).

In FIG. 6, the scaling offset is calculated. In some embodiments, the steps described in FIG. 6 can be modified by, for example, having steps rearranged, changed, added, and/or removed. At 601, a determination is made if Tₘₐₓ has increased. If yes (that is Tₘₐₓ has increased from the previous value of Tₘₐₓ), the process proceeds to 603. At 603, a calculation of the offset is made according to the formula in box 603, that is:

$$S = ( {T}_{U} - {T}_{composite , prev} - 1 ) / ( {T}_{U} - {T}_{max} ) \qquad ( eq . 2 )$$

Returning to 601, if no (that is Tₘₐₓ has not increased from the previous value of Tₘₐₓ), the process proceeds to 605. At 605, a determination is made if T_{board} has decreased. If yes (that is T_{board} has decreased from the previous value of T_{board}), the process proceeds to 607. At 607, a calculation of the offset is made according to the formula in box 607, that is:

$$S = ( {T}_{L} - {T}_{composite , prev} + 1 ) / ( {T}_{board} - {T}_{L} ) \qquad ( eq . 3 )$$

Returning to 605, if no (that is T_{board} has not decreased from the previous value of T_{board}), the process proceeds to 609, where the offset S is set to zero.

Accordingly, the scaling offset factor, S, looks at where the composite temperature currently is, and how far it needs to move before either the Tboard exits the lower end of the scaling range, or Tmax reaches the upper end of the scaling range. In other words,

$$S = \frac{\begin{matrix}( how much {T}_{composite} needs to move ) * \\ ( direction of movement )\end{matrix}}{how much of scaling window is left} \qquad ( eq . 4 )$$

This offset is calculated when the component of interest changes temperature and is added (or subtracted) to the previous composite temperature to compensate in the proper direction.

The inventive HCT determination provides a more stable and reliable temperature reading while being protective of all components. In data center applications, several drives may be grouped together and thermally controlled using fans by the host. As SSD technology advances, a higher level of accuracy in temperature reporting to optimize thermal control methods is needed. For example, a device's device-to-device composite temperature variation goal will be no more than +/−1° C. Two different devices are expected not to report a composite temperature greater than 2° C. apart under the same environmental conditions, slot location, and workload. Furthermore, a single device's composite temperature is expected not to vary by more than +/−1° C. once a steady state is reached under the same environmental conditions, slot location, and workload.

Prior to the present invention, the accuracy of the reported temperature was limited by the weakest (least accurate) temperature sensor which could be accurate to only +/−4° C. To improve, either the drive hardware would have to be upgraded so that all temperature sensors are accurate to +/−1° C., or a firmware approach such as the inventive HCT determination needs to be taken. Making hardware changes to use more accurate sensors is undesirable because it requires engineering work, product validation, and will likely increase the cost of the drive. The invention's firmware approach addresses this issue more elegantly by biasing the reported temperature to use the most accurate sensor, while still providing a failsafe in case a lower accuracy component passes its thermal limit.

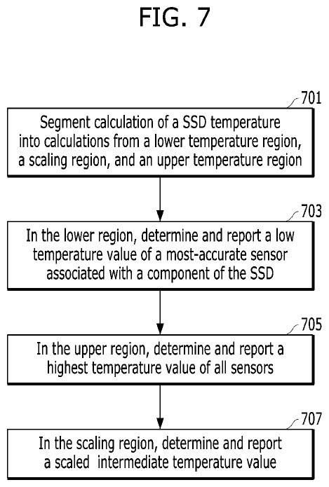

FIG. 7 is a flow chart depicting a method according to one embodiment of the invention for reporting a temperature of a solid state drive (SSD) to a controller of the SSD for thermal management of the SSD. This method can be for example programmed into the TCE 110. This method can be applied to other storage devices as the present invention is not limited to solid state drive memory devices although the method here in FIG. 7 is described with reference to SSDs. In some embodiments, the steps described in FIG. 6 can be modified by, for example, having steps rearranged, changed, added, and/or removed. This method at 701 segments calculation of a temperature of the SSD into calculations from a lower temperature region, a scaling region, and an upper temperature region. This method at 703 determines and reports in the lower region a low temperature value of a most-accurate sensor associated with a component of the SSD. While the reported value can be reported to memory controller 110, the present invention can report the value to any component used to affect the temperature of the SSD, such as fan 21. At 703, in one embodiment of the invention, the most-accurate sensor is more accurate than other sensors measuring temperatures on the SSD. This method at 705 determines in the upper region a highest temperature value of all sensors and reports the highest temperature value to the controller. Here again, while the reported value can be reported to memory controller 110, the present invention can report the temperature value to any component used to affect the temperature of the SSD, such as fan 21. This method at 707 reports in the scaling region a scaled intermediate temperature value scaled with respect to a point of entry temperature into the scaling region. Here again, while the reported value can be reported to memory controller 110, the present invention can report the temperature value to any component used to affect the temperature of the SSD, such as fan 21. While the reported value can be a temperature of the SSD, it can be a reported value obtained from other types of storage devices.

In this method, the low temperature value, the highest temperature value, and the scaled intermediate temperature value may comprise normalized temperatures, each providing a comparison to a maximum operating temperature of the component whose temperature is sensed.

In this method, the most-accurate sensor is more accurate than (or at least as accurate as one of the) all other sensors measuring temperatures on the SSD. In this method, the most-accurate sensor may comprise a board sensor (as for example the most accurate sensor) and the other sensors may comprise an SSD controller sensor and an SSD memory sensor.

In this method, the low temperature value may be determined utilizing inputs from the most-accurate sensor and at least one of the other sensors.

In this method, the high temperature value is reported for temperatures outside of a normal temperature operating range of the SSD. In an example, the normal temperature operating range of the SSD is less than 77° C., and the point of entry into the scaling region is at an operating temperature of 70° C.

In this method, the scaled intermediate temperature value (preferably) matches the low temperature value at the point of entry into the scaling region and (preferably) matches the high temperature value at a point of exit into the scaling region. In this method, the scaled intermediate temperature value can be scaled based on a scaling factor determining how far in temperature that an instant temperature for the reported scaled intermediate temperature value is from the lower region. In this method, the scaled intermediate temperature value can be scaled based on a scaling factor determining how far in temperature that an instant temperature for the reported scaled intermediate temperature value is from the upper region.

In this method, the low temperature value is accurate to +/−1° C. In this method, the SSD represents one type of storage device that the present invention can be applied to. In this method. at least one of the low temperature value, the highest temperature value, and the scaled intermediate temperature value may be reported to a controller of the storage device (such as memory controller 100) or to a fan for cooling one or more storage devices (such as fan 21).

In one embodiment of the present invention, there is provided a control system for thermal management of a storage device such as for example a solid state drive (SSD), the control system having a controller configured to: a) segment calculation of the temperature of the storage device into calculations from a lower temperature region, an upper temperature region, and a scaling region between the lower temperature region and the upper temperature region, b) in the lower temperature region, determine a low temperature value from at least one sensor associated with at least one component of the storage device, wherein the at least one sensor comprises a most-accurate sensor which is more accurate than other sensors in the low temperature region, c) in the upper temperature region, determine a highest temperature value of all sensors in order to protect the storage device from overheating, and d) in the scaling region, determine a scaled intermediate temperature value scaled with respect to a point of entry temperature into the scaling region.

In this embodiment, the low temperature value, the highest temperature value, and the scaled intermediate temperature value may comprise normalized temperatures, each providing a comparison to a maximum operating temperature of the component whose temperature is sensed.

In this embodiment, the most-accurate sensor is more accurate than (or at least as accurate as one of the) other sensors measuring temperatures on the storage device. The most-accurate sensor may comprise a board sensor and the other sensors may comprise a controller sensor and a memory sensor.

In this embodiment, the low temperature value may be determined utilizing inputs from the most-accurate sensor and at least one of the other sensors.

In this embodiment, the high temperature value may be determined for temperatures outside of a normal temperature operating range of the storage device. The normal temperature operating range of the storage device is less than 77° C. The point of entry into the scaling region is at an operating temperature of 70° C.

In this embodiment, the scaled intermediate temperature value (preferably) matches the low temperature value at the point of entry into the scaling region and (preferably) matches the high temperature value at a point of exit into the scaling region. In this method, the scaled intermediate temperature value can be scaled based on a scaling factor determining how far in temperature that an instant temperature for the reported scaled intermediate temperature value is from the lower region. In this method, the scaled intermediate temperature value can be scaled based on a scaling factor determining how far in temperature that an instant temperature for the reported scaled intermediate temperature value is from the upper region.

In this embodiment, the low temperature value is accurate to +/−1° C. In this embodiment, the storage device may comprise a solid state drive. In this embodiment, at least one of the low temperature value, the highest temperature value, and the scaled intermediate temperature value may be reported to a controller of the storage device (such as memory controller 100) or to a fan for cooling one or more storage devices (such as fan 21).

In another embodiment, there is provided a controller for determining a temperature (e.g., a composite temperature) of a storage device such as a solid state drive (SSD) for thermal management of the storage device. This controller is configured to a) segment calculation of the temperature of the storage device into calculations from a lower temperature region, an upper temperature region, and a scaling region between the lower and upper temperature regions, b) in the lower temperature region, determine a low temperature value from at least one sensor associated with at least one component of the storage device, c) in the upper temperature region, determines a highest temperature value of all sensors in order to protect the storage device from overheating, and d) in the scaling region, determine a scaled intermediate temperature value scaled with respect to a point of entry temperature into the scaling region.

In still another embodiment of the invention, there is provided a computer program product for determining a temperature (e.g., a composite temperature) of a storage device such as for example an SSD. The computer program product comprising a non-transitory computer readable medium which when executed on the controller causes the controller to a) segment calculation of the temperature of the storage device into calculations from a lower temperature region, an upper temperature region, and a scaling region between the lower and upper temperature regions, b) in the lower temperature region, determine a low temperature value from at least one sensor associated with at least one component of the storage device, c) in the upper temperature region, determines a highest temperature value of all sensors in order to protect the storage device from overheating, and d) in the scaling region, determine a scaled intermediate temperature value scaled with respect to a point of entry temperature into the scaling region.

In another embodiment, there is provided a memory system including a storage device such as for example an SSD and a controller for determining and/or controlling a temperature (e.g., a composite temperature) of the storage device. The controller is configured to a) segment calculation of the temperature of the storage device into calculations from a lower temperature region, an upper temperature region, and a scaling region between the lower and upper temperature regions, b) in the lower temperature region, determine a low temperature value from at least one sensor associated with at least one component of the storage device, c) in the upper temperature region, determines a highest temperature value of all sensors in order to protect the storage device from overheating, and d) in the scaling region, determine a scaled intermediate temperature value scaled with respect to a point of entry temperature into the scaling region. In this embodiment, the memory system shown in FIG. 1 may be a part of a data center having several solid state drives grouped together and thermally controlled using fans such as platform fan 21. In this embodiment, the storage device (or the solid state drives grouped together) can be thermally controlled using one of the power throttling techniques discussed above. In this embodiment, a temperature of the storage device can be controlled based on the determined temperature by adjusting an amount of power being consumed by the storage device. In this embodiment, the power being consumed can be changed by reducing or increasing a clock rate speed of the storage device. Alternatively, the power being consumed can be changed by regulating a time when garbage collection occurs such as not to perform garbage collection when the determined temperature exceeds an upper temperature limit. Alternatively, the power being consumed can be changed by de-powering a number of storage modules (die) in the storage device when the determined temperature exceeds an upper temperature limit.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives recognized by one skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “control system,” “memory system,” and “controller” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. The computer program can be embodied as a computer program product as noted above containing a computer readable medium.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

What is claimed is:

1. A method for determining a temperature of a storage device for thermal management of the storage device, comprising:
segmenting calculation of the temperature of the storage device into calculations from a lower temperature region, an upper temperature region, and a scaling region between the lower temperature region and the upper temperature region;
in the lower temperature region, determining a low temperature value from at least one sensor associated with at least one component of the storage device, wherein the at least one sensor comprises a most-accurate sensor which is more accurate than other sensors in the low temperature region;
in the upper temperature region, determining a highest temperature value of all sensors in order to protect the storage device from overheating; and
in the scaling region, determining a scaled intermediate temperature value scaled with respect to a point of entry temperature into the scaling region.

2. The method of claim 1, wherein the low temperature value, the highest temperature value, and the scaled intermediate temperature value comprise normalized temperatures, each providing a comparison to a maximum operating temperature of the component whose temperature is sensed.

3. The method of claim 2, wherein the most-accurate sensor comprises a board sensor and the other sensors comprise a controller sensor and a memory sensor.

4. The method of claim 1, wherein the determining a low temperature value utilizes inputs from the most-accurate sensor and at least one of the other sensors.

5. The method of claim 1, wherein the highest temperature value is reported for temperatures outside of a normal temperature operating range of the storage device.

6. The method of claim 4, wherein
the normal temperature operating range of the storage device is less than 77° C., and
the point of entry into the scaling region is at an operating temperature of 70° C.

7. The method of claim 1, wherein the scaled intermediate temperature value matches the low temperature value at the point of entry temperature into the scaling region and matches the high temperature value at a point of exit temperature from the scaling region.

8. The method of claim 7, wherein the scaled intermediate temperature value is scaled based on a scaling factor determining how far in temperature that an instant temperature for the scaled intermediate temperature value is from the lower region.

9. The method of claim 7, wherein the scaled intermediate temperature value is scaled based on a scaling factor determining how far in temperature that an instant temperature for the scaled intermediate temperature value is from the upper region.

10. The method of claim 1, wherein the low temperature value is accurate to +/−1° C.

11. A control system for thermal management of a storage device, the control system having a controller configured to:
segment calculation of the temperature of the storage device into calculations from a lower temperature region, an upper temperature region, and a scaling region between the lower temperature region and the upper temperature region;
in the lower temperature region, determine a low temperature value from at least one sensor associated with at least one component of the storage device, wherein the at least one sensor comprises a most-accurate sensor which is more accurate than other sensors in the low temperature region;
in the upper temperature region, determine a highest temperature value of all sensors in order to protect the storage device from overheating; and
in the scaling region, determine a scaled intermediate temperature value scaled with respect to a point of entry temperature into the scaling region.

12. The system of claim 11, wherein the low temperature value, the highest temperature value, and the scaled intermediate temperature value comprise normalized temperatures, each providing a comparison to a maximum operating temperature of the component whose temperature is sensed.

13. The system of claim 11, wherein the most-accurate sensor comprises a board sensor and the other sensors comprise a controller sensor and a memory sensor.

14. The system of claim 11, wherein the low temperature value is determined utilizing inputs from the most-accurate sensor and at least one of the other sensors.

15. The system of claim 11, wherein the highest temperature value is determined for temperatures outside of a normal temperature operating range of the storage device.

16. The system of claim 11, wherein
the normal temperature operating range of the storage device is less than 77° C., and
the point of entry into the scaling region is at an operating temperature of 70° C.

17. The system of claim 11, wherein the scaled intermediate temperature value matches the low temperature value at the point of entry temperature into the scaling region and matches the high temperature value at a point of exit temperature from the scaling region.

18. The system of claim 17, wherein the scaled intermediate temperature value is scaled based on a scaling factor determining how far in temperature that an instant temperature for the scaled intermediate temperature value is from the lower region.

19. The system of claim 17, wherein the scaled intermediate temperature value is scaled based on a scaling factor determining how far in temperature that an instant temperature for the scaled intermediate temperature value is from the upper region.

20. A memory system including a storage device and a controller for determining a temperature of the storage device, wherein the controller is configured to:
segment calculation of the temperature of the storage device into calculations from a lower temperature region, an upper temperature region, and a scaling region between the lower and upper temperature regions,
in the lower temperature region, determine a low temperature value from at least one sensor associated with at least one component of the storage device, wherein the at least one sensor comprises a most-accurate sensor which is more accurate than other sensors in the low temperature region;
in the upper temperature region, determine a highest temperature value of all sensors in order to protect the storage device from overheating; and
in the scaling region, determine a scaled intermediate temperature value scaled with respect to a point of entry temperature into the scaling region.
